(19) United States
(12) Patent Application Publication
(10) Pub. No.: US 2016/0088910 A1
(43) Pub. Date: Mar. 31, 2016

(54) Carbon Fiber Equestrian Tack Trunk

(71) Applicant: Ryan Christopher AXTON, Lake Stevens, WA (US)

(72) Inventor: Ryan Christopher Axton, Lake Stevens, WA (US)

(21) Appl. No.: 14/893,888

(22) PCT Filed: May 27, 2014
(86) PCT No.: PCT/US14/39608

§ 371 Date: Nov. 24, 2015

Related U.S. Application Data
(60) Provisional application No. 61/828,079, filed on May 28, 2013.

(51) Int. Cl. A45C 5/02; A45C 11/24; B29C 70/06; A45C 13/02; B29C 70/44; A45C 5/04; A45C 13/00

(52) U.S. Cl. CPC A45C 5/02; A45C 5/04; A45C 11/24; A45C 13/005; A45C 13/02; B29C 70/443; B29C 70/06; B29K 2307/04

(57) ABSTRACT

A carbon fiber tack trunk is described. In an example, an equestrian tack trunk comprises a base, walls and a lid made from carbon fiber. In another example, a method is described to fabricate a carbon fiber tack trunk. The method may include manufacturing composite parts of the carbon fiber equestrian tack trunk from carbon fiber. The composite parts may be seamed to fabricate the carbon fiber equestrian tack trunk.

### BACKGROUND

Tack trunks have been an extremely useful device for individuals in the equestrian field for many decades. For example, track trunks may be used in eventing or barn use. Track trunks serve as a vessel for hauling and storing the riders gear/tack. Tack trunks are a sign of prestige and elegance. Tack trunks, however, may be very heavy and susceptible to weathering.

### SUMMARY

The following is directed to technologies relating to carbon fiber tack trunks. In an example, an equestrian tack trunk comprises a base, walls and a lid made from carbon fiber. In another example, a method is described to fabricate a carbon fiber tack trunk. The method may include manufacturing composite parts of the carbon fiber equestrian tack trunk from carbon fiber. The composite parts may be seamed to fabricate the carbon fiber equestrian tack trunk.

The foregoing Summary is illustrative only and is not intended to be in any way limiting. In addition to the illustrative aspects, embodiments, and features described above, further aspects, embodiments, and features will become apparent by reference to the Figures and the following Detailed Description.

### BRIEF DESCRIPTION OF THE DRAWINGS

FIG. 1 is a perspective view of a carbon fiber tack trunk with the lid in a closed position;

FIG. 2 is a perspective view of a carbon fiber tack trunk with the lid in an open position;

FIG. 3 is a perspective view a carbon fiber tack trunk with the lid an open position that has been filled in with gray for a more relative view; and

FIG. 4 is a flow diagram illustrating fabricating a carbon fiber tack trunk, in accordance with at least some embodiments presented herein.

### DETAILED DESCRIPTION

The following detailed description is directed to technologies for constructing a tack trunk from carbon fiber. Tack trunks have been an extremely useful device for those in the equestrian field for many decades. For example, track trunks may be used in eventing or barn use. Track trunks serve as a vessel for hauling and storing the riders gear/tack. Tack trunks are a sign of prestige and elegance.

Composites, such as carbon fiber, are used for construction of a tack trunk. As compared to tack trunks made from wood, carbon fiber tack trunks are much lighter in weight. Carbon fiber may also be more durable compared to wood. A carbon fiber tack trunk might also have and maintain a high cosmetic value.

As described herein, a carbon fiber tack trunk may be fabricated to perform the same duties of traditional tack trunks. A carbon fiber tack trunk, however, is light in weight and a single person might be able to easily move it from place to place. A wood tack trunk, however, can weigh over 100 lbs. making it difficult for a single person to move it. Carbon fiber is very strong and durable in outdoor settings, in which tack trunks commonly reside in. In contrast, wood, metal and plastic tend to disintegrate over a short time leaving a tack trunk made of the material not fit for the intended purpose.

A carbon fiber tack trunk may be of many different visual appearances. For example, carbon fiber may have complex weaves and patterns. Carbon fiber hybrids may be colorized in the fiber barring material and well as shaped and woven into almost any format or shape. These options allow for individuals and barns to customize a tack trunk. As such, one individual's tack trunk might be individualized from other tack trunks. In some cases, different competitors might have tack trunks that have a different appearance from other tack trunks at an event.

The Equestrian field is currently in a state of update going from traditional to more performance orientated. A composite fiber tack trunk may provide a beautiful and timeless look while still holding the value of what a tack trunk was designed for. As discussed above, a carbon fiber tack trunk may provide easier carrying of one's gear/tack from location to location since carbon fiber is generally very light and strong.

In some examples, tack trunks are constructed from carbon fiber material as well as carbon fiber hybrids infused with resin to provide its finished structure. Carbon fiber comes in varying weights and weaves. Different carbon fiber might be selected for different tack trunks. For example, a carbon fiber might be selected based at least in part on its reference variances. In some cases, 1 k, 3 k, 6 k, 12 k are the amount of strands of fibers in the tow. Giving them each uses in different aspects of composites. Different Carbon Fiber weights can be used separately or combined to achieve desired construction for strength and other properties.

Multiple carbon fiber layers and cores may be used to add strength, thickness and stiffness. Cores may include but not limited to Birch, Balsa, Honeycomb, Foam, PET, Cormat, and Soric.

Resin also be used in composites as a binding element for reinforcement fabric. Resins such as epoxy, vinylester and polyester may be used in producing carbon fiber parts. Resins are a liquid until cured using a catalyst or hardener. Once cured the resin becomes a solid with many beneficial properties and essential to the carbon fiber composite makeup.

Different fabrication methods might be used to fabricate a carbon fiber tack trunk. In some examples, a master is made to mirror the shape and size of each part that is going to be built. A master might be made from a material other than carbon fiber, such as wood, foam, clay, or plastic. In other examples, the master might be made from carbon fiber.

A composite mold may be created using that master. The composite mold may then be used to fabricate the carbon fiber tack trunk. For example, layers of carbon fiber with the possibility of a core material may then be laid up inside the mold. In some example, a layer of carbon fiber is used for the exterior and a layer of carbon fiber is used for the interior. There might also be supporting layers of carbon fiber and or core in between.

In some examples, a wet layup technique may be used in manufacturing composite parts of the carbon fiber tack trunk. In other examples, vacuum bagging may be used in manufacturing composite parts of the carbon fiber tack trunk. Vacuum infusion might also be used in manufacturing composite parts of the carbon fiber tack trunk. In still other examples, the use of pre-impregnated carbon fiber may be used in manufacturing composite parts of the carbon fiber tack trunk. Generally, any method that uses carbon fiber to create a tack trunk might be used when fabricating the carbon fiber tack trunk.

A variation of implementation could be and not limited to the use of pre-made carbon fiber panels. Using resin or adhesive, the panels could be adhered together forming a rectangular trunk with approximately ninety-degree corners. Other angles might be formed (e.g., between 70-120 degrees). The interior parts, such as tray and tote, might similarly be fashioned.

As discussed briefly above, a tack trunk may have various sizes that ranges in height, width, and length, as well as wall thickness. A common and standard size of tack trunks is approximately 36 inches in length, 24 inches in height and 24 in inches in width. Generally, any size range might be used such that it still fits into its realm as an equestrian tack trunk.

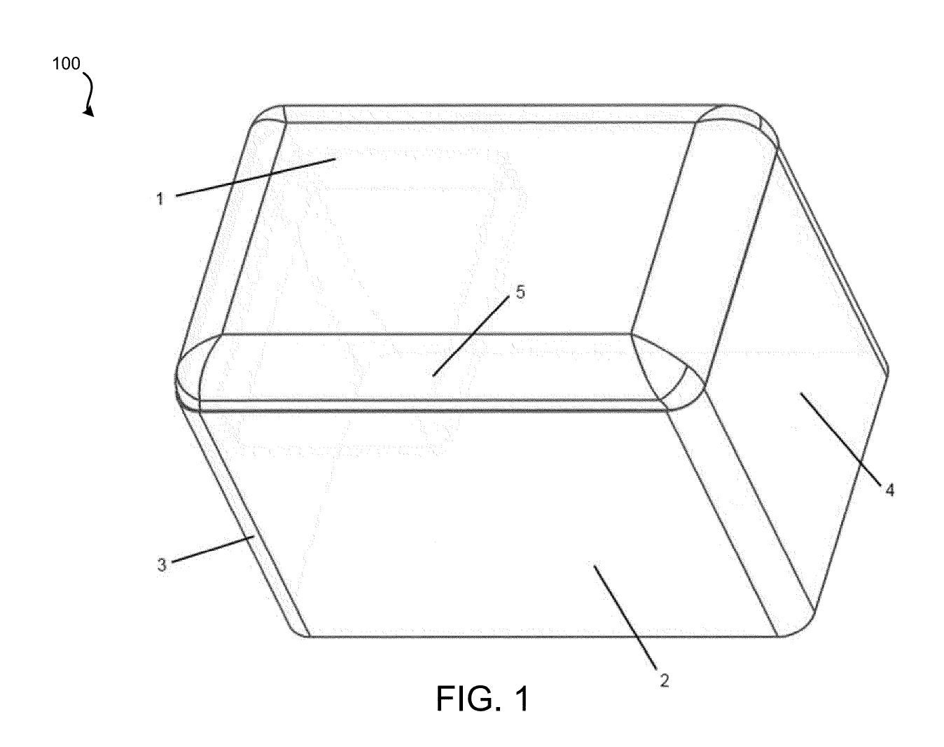

As shown in FIG. 1 through FIG. 3, the tack trunk structure according to examples includes a carbon fiber outer reinforcement 2 and a carbon fiber inner reinforcement 6 which are integrally formed. The trunk base has four vertical walls and one horizontal wall.

The lid 1 illustrates a horizontal wall with swooping corners that returns to short vertical walls. A removable sliding tray 8 may be held up by a small rail that runs the length of the trunk on front and back walls. The interior of the wall 7 is shown, being multiple layers of carbon fiber and or core material. As is the outer reinforcement 2 and inner reinforcement 6.

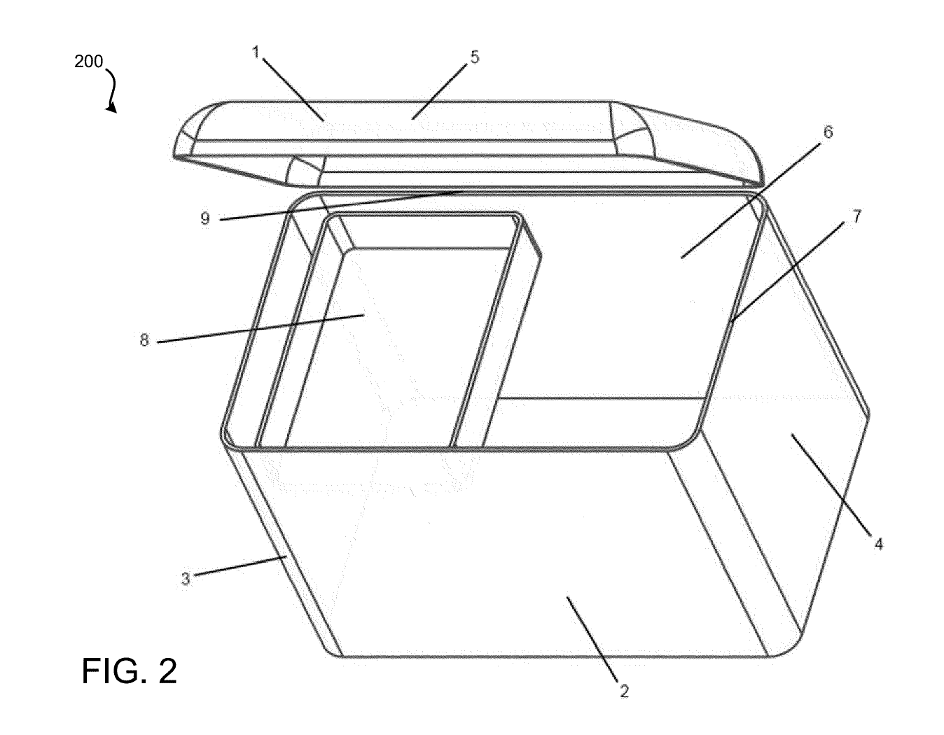

The corners 3 of the tack trunk illustrated in FIGS. 1-3 show a rounded element. The corners 3, however, may be formed differently (e.g., square, beveled, scalloped). A location 5 for a hasp (not shown) is shown in FIGS. 1-3. A handle location 4 shows an approximate location of where handles (not shown) may be placed. Generally, handles may be placed on the ends of the trunk with understanding that on the opposing wall contains its counterpart. Different hardware might be placed on the carbon fiber tack trunk. For example, a hinge (not shown) might be placed along location 9 illustrated in FIG. 2. In some examples, these parts (e.g., handles, hasps, hinges) may be interchangeable on the same or different tack trunks.

Referring further to FIG. 1, a lid 1 shows a contour of the rounded corners and slope of its shape. In other examples, other shapes might be used during fabrication of a carbon fiber tack trunk. For example, the shape and contours might be changed as a result of a strength function or cosmetic function. Similarly, the base corners 3 might be changed.

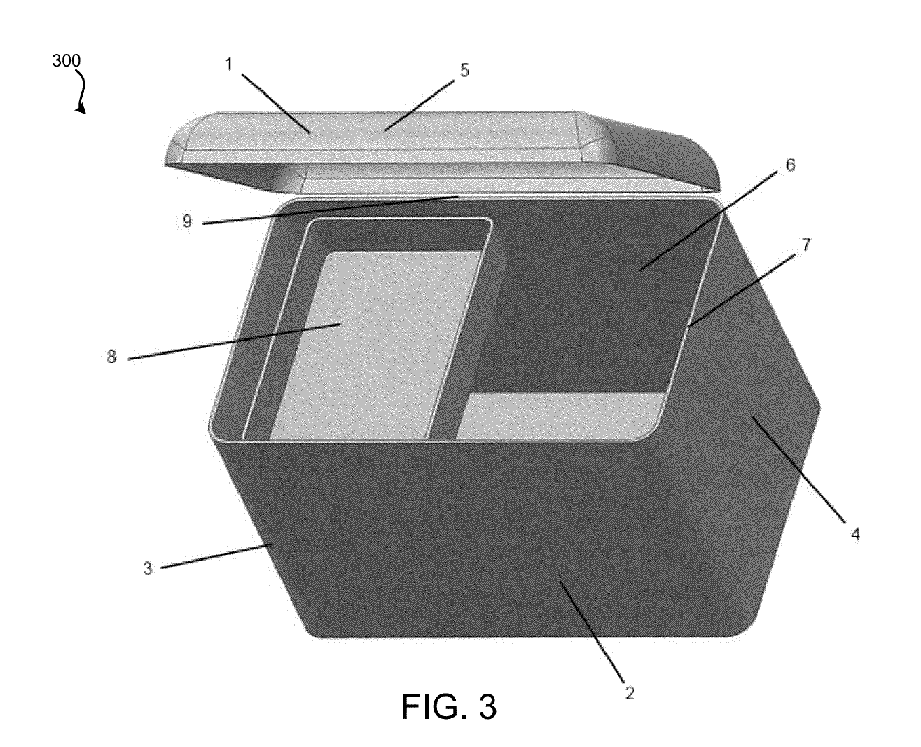

Referring further to FIG. 2 and FIG. 3, a wall thickness 7 might be various wall thicknesses. In some examples, the wall thickness 7 might range from ⅛ inch to 1 inch.

Referring further to FIG. 3 the gray filled in color is a closer resemblance to the carbon fiber reinforcement without creating a complex and suggestive pattern. In some examples, carbon fiber material is used to fabricate the entire tack trunk. In other examples, the carbon fiber material might be used to fabricate a majority of the tack trunk (e.g., greater than 70% of total area made out of carbon fiber). It should be evident from the foregoing description and drawings in terms of the present invention, the tack trunk may have camber or grooving for structural support. It is to help improve the yield of the invention.

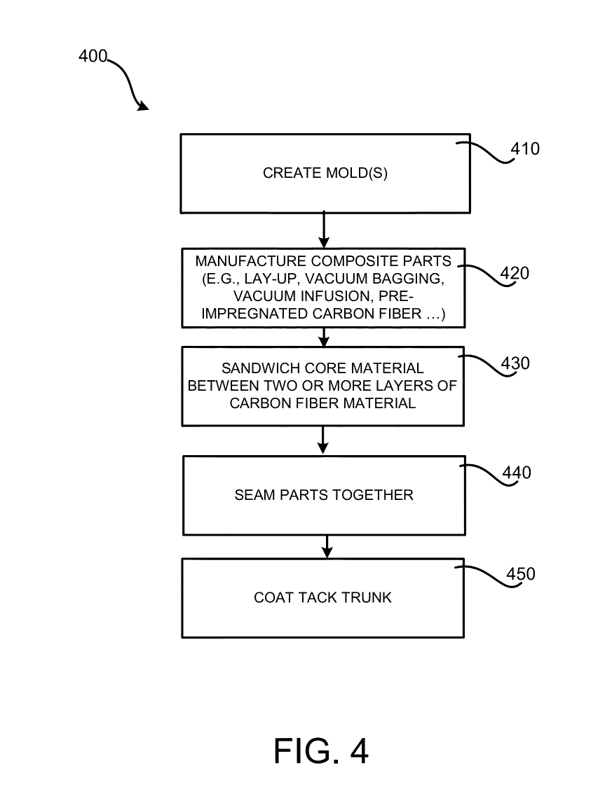

FIG. 4 shows a flow diagram for fabricating a carbon fiber equestrian tack trunk. The process 400 might start at operation 410 where a carbon fiber tack trunk is fabricated by sandwiching a core material in between two or more layers of carbon fiber material reinforcement. As discussed above, a resin system may be used to encompass the composite part.

The process 400 may continue to operation 420, where the composite parts are manufactured. As discussed above, the composite parts might be formed using one or more of the following techniques, including, but not limited to lay-up, vacuum bagging, vacuum infusion, per-impregnated carbon fiber, and the like.

The process 400 may continue to operation 430, where core material might be sandwiched between two or more layers of carbon material.

The process 400 may continue to operation 440, where the parts may be seamed together. For example, multiple pieces of carbon fiber may be laid up in a way which such that numerous pieces are seamed together constructing the final interior and exterior reinforcements. Resin may be used in conjunction with the carbon fiber to achieve its composite makeup. Other methods might also be used to seam together the different pieces.

The process 400 may continue to operation 450, where a coating may be placed on the tack trunk. For example, finishes as clear coats, gel coats and lacquer may be used to protect the carbon fiber tack trunk from UV lighting as well as from moisture. A coating might also provide extra protection for the composite materials. The process 400 may then end.

While the subject matter described above has particularly shown and described with reference to different embodiments, it will be understood by those skilled in the art that numerous changes, modifications, and substitutions of equivalents may be made therein without departing from the spirit and scope of the invention.

1. An equestrian tack trunk, comprising:
a base made from carbon fiber;
walls of the trunk made from carbon fiber that are coupled to the base; and
a lid made from carbon fiber that is coupled to at least one of the walls.

2. The equestrian tack trunk of claim 1, wherein the base, the walls and the lid are made from a sheet of carbon fiber that is molded from at least one of a press, a vacuum or a wet lay-up.

3. The equestrian tack trunk of claim 1, wherein the carbon fiber is a single sheet of carbon fiber.

4. The equestrian tack trunk of claim 1, further comprising a carbon fiber tray that is located within an interior portion of the equestrian tack trunk.

5. The equestrian tack trunk of claim 3, further comprising a carbon fiber tray that is located within an interior portion of the equestrian tack trunk.

6. The equestrian tack trunk of claim 1, wherein the carbon fiber material includes at least one of a resin or a pre-impregnated carbon fiber.

7. The equestrian tack trunk of claim 1, wherein at least a portion of corners of the equestrian tack trunk are rounded.

8. The equestrian tack trunk of claim 1, wherein the lid is coupled to at least one of the walls using a hinge.

9-11. (canceled)

12. A method for fabricating a carbon fiber equestrian tack trunk, comprising the steps of:
manufacturing composite parts of the carbon fiber equestrian tack trunk, wherein the composite parts are made from carbon fiber;
seaming the composite parts to fabricate the carbon fiber equestrian tack trunk.

13. The method of claim 12, wherein manufacturing the composite parts of the carbon fiber equestrian tack trunk comprises using at least one of a press, a vacuum or a wet lay-up.

14. The method of claim 12, wherein the composite parts comprise a bottom, a lid and walls.

15. The method of claim 12, wherein the composite parts comprise a tray.

16-20. (canceled)

21. The equestrian tack trunk of claim 1, further comprising a coating applied to at least one of: the base, the walls, and the lid.

22. The equestrian tack trunk of claim 1, further comprising a coating applied to at least one of: the base, the walls, and the lid wherein the coating is at least one of a UV coating or a coating to protect against moisture.

23. The equestrian tack trunk of claim 1, wherein the carbon fiber material includes at least one of a resin or a pre-impregnated carbon fiber.

24. The method of claim 12, wherein manufacturing the composite parts comprises sandwiching a core material between two or more layers of carbon fiber material reinforcement.

25. The method of claim 12, wherein manufacturing the composite parts comprises using a resin.

26. The method of claim 12, wherein manufacturing the composite parts of the carbon fiber equestrian tack trunk comprises using at least one of a press, a vacuum or a wet lay-up.

27. The method of claim 12, wherein the composite parts comprise a bottom, a lid and walls.

28. The method of claim 12, wherein the composite parts comprise a tray.
